(19) United States
(12) Patent Application Publication
(10) Pub. No.: US 2009/0247307 A1
(43) Pub. Date: Oct. 1, 2009

(54) DAMPER DEVICE

(75) Inventors: Kazunori Ishikawa, Toyota-shi (JP); Kazuyoshi Ito, Anjo-shi (JP); Keizo Araki, Anjo-shi (JP); Yuito Abe, Nishio-shi (JP); Masahiro Yamaguchi, Sabae-shi (JP); Osamu Yoshida, Sabae-shi (JP); Koji Kobayashi, Fukui-shi (JP); Tatsuya Iida, Echizen-shi (JP); Yusuke Shinjo, Sabae-shi (JP)

Correspondence Address: SUGHRUE MION, PLLC, 2100 PENNSYLVANIA AVENUE, N.W., SUITE 800, WASHINGTON, DC, 20037, US

(73) Assignees: AISIN AW CO., LTD, Anjo-shi (JP); AISIN AW INDUSTRIES CO., LTD., Takefu-shi (JP)

(21) Appl. No.: 12/412,838

(22) Filed: Mar. 27, 2009

(30) Foreign Application Priority Data
Mar. 31, 2008 (JP) 2008-091409

(51) Int. Cl. F16F 15/121

(52) U.S. Cl. 464/68.8

(57) ABSTRACT

A damper device includes a drive plate; a driven plate; and a torque transmission mechanism having different types of damper springs. The torque transmission mechanism transmits torque of the drive plate to the driven plate via at least one of the damper springs, wherein the torque transmission mechanism is structured to allow a combination of damper springs acting during torque transmission to be changed at lease three times as a rotation angle of the drive plate relative to the driven plate becomes greater. Each of the damper springs can be extended and compressed circumferentially about the rotation axis and is disposed at the same radial position about the rotation axis.

The disclosure of Japanese Patent Application No. 2008-091409 filed on Mar. 31, 2008 including the specification, drawings and abstract is incorporated herein by reference in its entirety.

### BACKGROUND OF THE INVENTION

1. Field of the Invention

The present invention relates to a damper device capable of absorbing torque vibration generated in a drive power source, such as an engine.

2. Description of the Related Art

Japanese Patent Application Publication No. JP-A-2004-278744 discloses a known damper device capable of absorbing torque vibrations generated in a drive power source. The damper device includes a damper plate, a damper disc, and a torque transmission mechanism. Specifically, the damper plate as a drive plate is connected to an engine side of a vehicle and is rotatable about a predetermined rotation axis; the damper disc as a driven plate is relatively rotatable coaxially with the damper plate; the torque transmission mechanism transmits torque of the damper plate to the damper disc. The torque transmission mechanism includes three damper springs, each having a different length in an extension/compression direction in a steady state, i.e., when no stress in the extension/compression direction is applied. A first damper spring and a second damper spring of these three damper springs are disposed at the same radial position about the rotation axis, while a third damper spring is disposed radially outwardly of the other damper springs.

Each of the damper plate and the damper disc has a torque transmission portion dedicated to each damper spring of the torque transmission mechanism. Specifically, each torque transmission portion dedicated to the first damper spring in each of the damper plate and the damper disc is formed to be capable of transmitting torque relative to the first damper spring at all times. Each torque transmission portion dedicated to the second damper spring in each of the damper plate and the damper disc is formed to be capable of transmitting torque relative to the second damper spring when the damper plate rotates through an angle (also called “torsion angle”) of a first predetermined angle or more relative to the damper disc. Further, each torque transmission portion dedicated to the third damper spring in each of the damper plate and the damper disc is formed to be capable of transmitting torque relative to the third damper spring when the above-described angle becomes equal to, or more than, a second predetermined angle that is greater than the first predetermined angle.

When torque is transmitted from the engine side to the damper device described above, the damper plate and the damper disc rotate about the rotation axis in a condition having a rotation angle corresponding to the magnitude of the torque. Specifically, when the damper plate rotates through less than the first predetermined angle relative to the damper disc, the torque transmitted to the damper plate from the engine side is transmitted to the damper disc via the first damper spring of the torque transmission mechanism. As the engine torque thereafter builds up and the damper plate rotates through the first predetermined angle or more relative to the damper disc, torque can then be transmitted to the damper disc also from the second damper spring. Accordingly, at this time, the torque transmitted from the engine side to the damper plate is transmitted to the damper disc via the first damper spring and the second damper spring. When the engine torque thereafter builds up further and the damper plate rotates through the second predetermined angle or more relative to the damper disc, torque can then be transmitted to the damper disc also from the third damper spring. Accordingly, at this time, the torque transmitted from the engine side to the damper plate is transmitted to the damper disc via the first damper spring, the second damper spring, and the third damper spring.

The above-described damper device includes the three different types of damper springs so that a relationship between the rotation angle of the damper plate relative to the damper disc and the torque transmitted from the damper plate to the damper disc is changed in three steps. The third damper spring is, however, disposed radially outwardly of the other damper springs. The above-described damper device is arranged to have the damper springs at two different radial positions. This poses a problem of an enlarged radial dimension.

### SUMMARY OF THE INVENTION

One aspect of the non-limiting embodiments of the present invention is to provide a damper device that can contribute a reduction in radial size.

To achieve the foregoing aspect, a damper device according to the exemplary embodiments of the present invention includes: a drive plate rotatable about a predetermined rotation axis; a driven plate disposed so as to be relatively rotatable coaxially with the drive plate; and a torque transmission mechanism having at least damper springs of a plurality of types that are different from each other in at least one of a radial size, a length in an extension/compression direction in a steady state, and an extension/compression ratio, the torque transmission mechanism transmitting torque of the drive plate to the driven plate via at least one of the damper springs. The torque transmission mechanism is structured to allow a combination of damper springs acting during torque transmission from the drive plate to the driven plate to be changed at lease three times as a rotation angle of the drive plate relative to the driven plate becomes greater. Each of the damper springs can be extended and compressed circumferentially about the rotation axis and is disposed at the same radial position about the rotation axis.

According to the above-described arrangement, in the damper device that allows the combination of the damper springs acting during torque transmission from the drive plate to the driven plate to be changed at least three times as the rotation angle of the drive plate relative to the driven plate becomes greater, all damper springs are disposed at the same radial positions. Therefore, as compared with the related art in which the damper springs are disposed at a plurality of positions that are radially different from each other, this arrangement can contribute to a reduction in radial size.

In an aspect of the exemplary embodiments of the present invention, of the damper springs, damper springs of two different types each having a radial size different from each other, are disposed in an overlapping manner such that the damper springs of the two different types coaxially overlap each other in a circumferential direction about the rotation axis.

According to the above-described arrangement, the damper springs of a plurality of types can be disposed to overlap each other in the circumferential direction. As compared with an arrangement in which the damper springs do not overlap each other in the circumferential direction, this arrangement can reduce the space for disposing the damper springs in the circumferential direction, and contribute to a size reduction of the entire damper device.

In an aspect of the exemplary embodiments of the present invention, the drive plate includes a first torque transmission portion capable of transmitting torque to at least one of the damper springs in the circumferential direction, and the driven plate includes a second torque transmission portion capable of transmitting torque to at least one of the damper springs in the circumferential direction. The torque transmission mechanism includes a third torque transmission portion capable of transmitting torque to each of the two damper springs disposed on a side of the first torque transmission portion and on a side of the second torque transmission portion in the circumferential direction. Damper springs of two different types having a radial size different from each other are disposed in the overlapping manner in a position of at least one of between the first torque transmission portion and the third torque transmission portion in the circumferential direction, and between the third torque transmission portion and the second torque transmission portion in the circumferential direction.

According to the above-described arrangement, the damper springs of two different types are disposed in the overlapping manner between the torque transmission portions that are adjacent to each other in the circumferential direction. A space for disposing the damper springs can therefore be set effectively, so that the damper device can be reduced in size.

In an aspect of the exemplary embodiments of the present invention, damper springs of two different types, each having a different radial size and a different length in an extension/compression direction in a steady state from each other, are disposed in the overlapping manner between the third torque transmission portion and another torque transmission portion disposed on a first side of the third torque transmission portion in the circumferential direction. The longer damper spring of the damper springs of the two different types is formed so as to be capable of transmitting torque individually to each of the two torque transmission portions disposed on either side in the circumferential direction The shorter damper spring is formed so as to become able to transmit torque individually to each of the two torque transmission portions disposed on either side in the circumferential direction when the rotation angle becomes equal to, or more than, a first predetermined angle that is set in advance to change the combination of the damper springs acting during torque transmission. Damper springs of two different types, each having a radial size different from each other and an equivalent length in an extension/compression direction in a steady state, are disposed in the overlapping manner between the third torque transmission portion and another torque transmission portion disposed on a second side of the third torque transmission portion in the circumferential direction. The damper springs of the two different types are formed so as to be capable of transmitting torque at all times individually to each of the two torque transmission portions disposed on either side in the circumferential direction. Between the third torque transmission portion and the other torque transmission portion disposed on the second side of the third torque transmission portion in the circumferential direction, a restriction portion is disposed that restricts the relative approach between the third torque transmission portion and the other torque transmission portion when the rotation angle becomes equal to, or more than, a second predetermined angle greater than the first predetermined angle, the second predetermined angle being set in advance to change again the combination of the damper springs acting during torque transmission.

According to the above-described arrangement, by combining the damper springs of three or four different types with the restriction portion, three different combinations of the damper springs acting during torque transmission from the drive plate to the driven plate can be set according to the rotation angle of the drive plate relative to the driven plate.

In an aspect of the exemplary embodiments of the present invention, damper springs of two different types, each having a radial size different from each other and a length in an extension/compression direction in a steady state different from each other, are disposed in the overlapping manner between the third torque transmission portion and another torque transmission portion disposed on a first side of the third torque transmission portion in the circumferential direction. The longer damper spring of the damper springs of the two different types is formed so as to be capable of transmitting torque at all times individually to each of the two torque transmission portions disposed on either side in the circumferential direction. The shorter damper spring is formed so as to become able to transmit torque individually to each of the two torque transmission portions disposed on either side in the circumferential direction when the rotation angle becomes equal to, or more than, a first predetermined angle that is set in advance to change the combination of the damper springs acting during torque transmission. Damper springs of two different types, each having a radial size different from each other and a length in an extension/compression direction in a steady state different from each other, are disposed in the overlapping manner between the third torque transmission portion and another torque transmission portion disposed on a second side of the third torque transmission portion in the circumferential direction. The longer damper spring of the damper springs of the two different types is formed so as to be capable of transmitting torque at all times individually to each of the two torque transmission portions disposed on either side in the circumferential direction. The shorter damper spring is formed so as to become able to transmit torque individually to each of the two torque transmission portions disposed on either side in the circumferential direction when the rotation angle becomes equal to, or more than, a second predetermined angle greater than the first predetermined angle, the second predetermined angle being set in advance to change again the combination of the damper springs acting during torque transmission.

According to the above-described arrangement, the combination of the damper springs acting during torque transmission from the drive plate to the driven plate can be changed three times as the rotation angle of the drive plate relative to the driven plate becomes greater, without providing a restriction portion that works to cancel an urging force of part of the damper springs when the damper device rotates. Therefore, this arrangement can contribute to simplification of the structure of the damper device because there is no need to provide the restriction portion.

In an aspect of the exemplary embodiments of the present invention, damper springs of two different types, each having a radial size different from each other and a length in an extension/compression direction in a steady state different from each other, are disposed in the overlapping manner between the third torque transmission portion and another torque transmission portion disposed on a first side of the third torque transmission portion in the circumferential direction. The longer damper spring of the damper springs of the two different types is formed so as to be capable of transmitting torque at all times individually to each of the two torque transmission portions disposed on either side in the circumferential direction. The shorter damper spring is formed so as to become able to transmit torque individually to each of the two torque transmission portions disposed on either side in the circumferential direction when the rotation angle becomes equal to, or more than, a first predetermined angle that is set in advance to change the combination of the damper springs acting during torque transmission. A damper spring capable of transmitting torque, at all times, individually to each of the two torque transmission portions disposed on either side in the circumferential direction is disposed between the third torque transmission portion and another torque transmission portion disposed on a second side of the third torque transmission portion in the circumferential direction. Between the third torque transmission portion and the other torque transmission portion disposed on one of the first side and the second side of the third torque transmission portion in the circumferential direction, a restriction portion is disposed that restricts a relative approach between the third torque transmission portion and the other torque transmission portion disposed on one of the first side and the second side when the rotation angle becomes equal to, or more than, a second predetermined angle greater than the first predetermined angle, the second predetermined angle being set in advance to change again the combination of the damper springs acting during torque transmission.

According to the above-described arrangement, by combining the damper springs of two or three different types with the restriction portion, the combination of the damper springs acting during torque transmission from the drive plate to the driven plate can be changed three times as the rotation angle of the drive plate relative to the driven plate becomes greater.

In an aspect of the exemplary embodiments of the present invention, each of the damper springs capable of transmitting torque, at all times, individually to each of the two torque transmission portions disposed on either side in the circumferential direction, of the damper springs disposed on both sides of the third torque transmission portion in the circumferential direction, is of the same type.

The above-described arrangement can contribute to a reduction in manufacturing cost because the number of types of damper springs used in the damper device can be reduced.

In an aspect of the exemplary embodiments of the present invention, of the two damper springs disposed in the overlapping manner, the damper spring having a shorter length in the extension/compression direction in the steady state is formed to have a smaller radial size than the damper spring having a longer length in the extension/compression direction in the steady state and is disposed in a space formed inside the damper spring having the longer length.

According to the above-described arrangement, the damper spring having the shorter length in the extension/compression direction in the steady state is accommodated in the internal space of the damper spring having the longer length. Therefore, the internal space of the longer damper spring can be effectively used.

In an aspect of the exemplary embodiments of the present invention, the restriction portion is disposed in a space formed inside the damper spring disposed at the same position in the circumferential direction.

According to the above-described arrangement, the restriction portion is disposed in the internal space of the damper spring. Therefore, the internal space of the damper spring can be effectively used. As compared with an arrangement in which the restriction portion is disposed at a radially different position from the damper spring, this arrangement can contribute to a reduction in the radial size.

In an aspect of the exemplary embodiments of the present invention, a seat member is disposed on each of both ends in the circumferential direction of the damper spring capable of transmitting torque at all times individually to each of the two torque transmission portions disposed on either side in the circumferential direction. The seat member is also capable of abutting an end in the circumferential direction a damper spring disposed in the overlapping manner with the damper spring. At least one of the two seat members includes a protrusion formed thereon, the protrusion extending in the circumferential direction inside the damper spring and serving as the restriction portion.

According to the above-described arrangement, as compared with an arrangement in which a restriction portion is provided in addition to the seat member, an increase in the number of parts can be inhibited.

In an aspect of the exemplary embodiments of the present invention, the protrusion is formed to taper from a proximal end to a distal end thereof.

According to the above-described arrangement, unlike an arrangement in which the protrusion is columnar, a compressed damper spring can be inhibited from contacting the protrusion.

### BRIEF DESCRIPTION OF THE DRAWINGS

FIG. 1 is a cross-sectional view showing a starting device according to a first exemplary embodiment of the present invention;

FIG. 2 is a partially cutaway cross-sectional view showing the arrangement of a damper device;

FIG. 3 is a schematic cross-sectional view schematically showing how various types of damper springs and stoppers are disposed;

FIG. 4 is a schematic view showing how various types of damper springs are disposed in a second exemplary embodiment of the present invention;

FIG. 5 is a schematic view showing how various types of damper springs are disposed in a third exemplary embodiment of the present invention; and

FIG. 6 is a schematic view showing how various types of damper springs are disposed in a further exemplary embodiment of the present invention.

### DETAILED DESCRIPTION OF THE EXEMPLARY EMBODIMENTS

### First Exemplary Embodiment

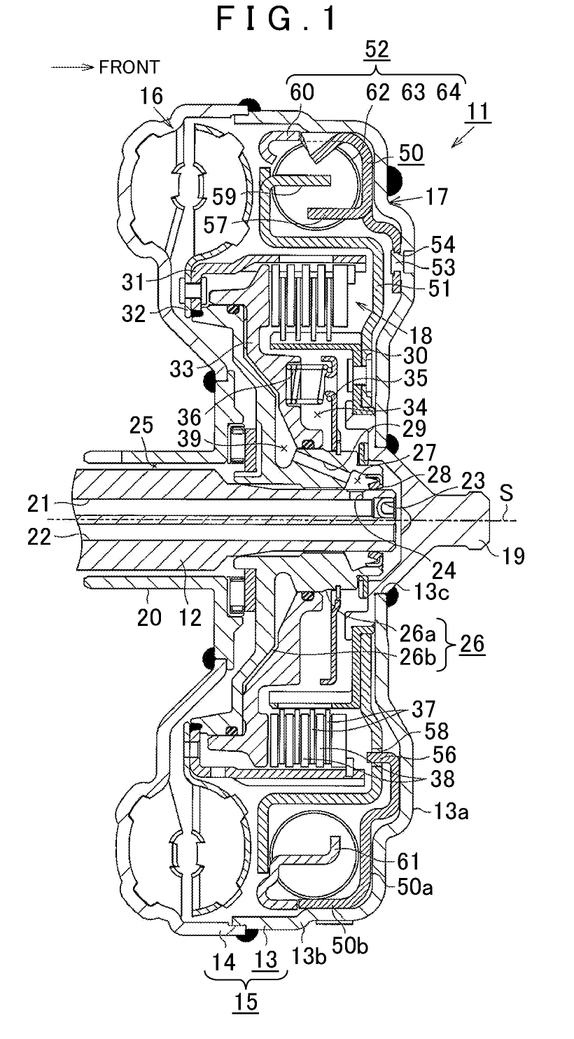

A first exemplary embodiment of the present invention as embodied in a starting device to be mounted in a vehicle will be described with reference to FIGS. 1 through 3. Note that, in the description that follows, “front side” is the right-hand side in FIG. 1 and “rear side” is the left-hand side in FIG. 1.

Referring to FIG. 1, a starting device 11 according to the present exemplary embodiment transmits torque (rotating force) generated in an engine (not shown) as a drive source to an input shaft 12 of a speed change mechanism (not shown). Specifically, the starting device 11 includes a housing 15 that includes a front cover 13 and a pump cover 14. The front cover 13 has a substantially cylindrical shape with a bottom connected to an output side of the engine. The pump cover 14 is fixed to an outer peripheral side end portion of the front cover 13 through welding. The housing 15 is filled therein with a hydraulic fluid, such as hydraulic oil. In addition, the housing 15 accommodates therein a fluid coupling 16, a damper device 17, and a clutch mechanism 18. The damper device 17 can absorb torque vibration generated in the engine. The clutch mechanism 18 can transmit torque transmitted from the damper device 17 directly to the input shaft 12 of the speed change mechanism.

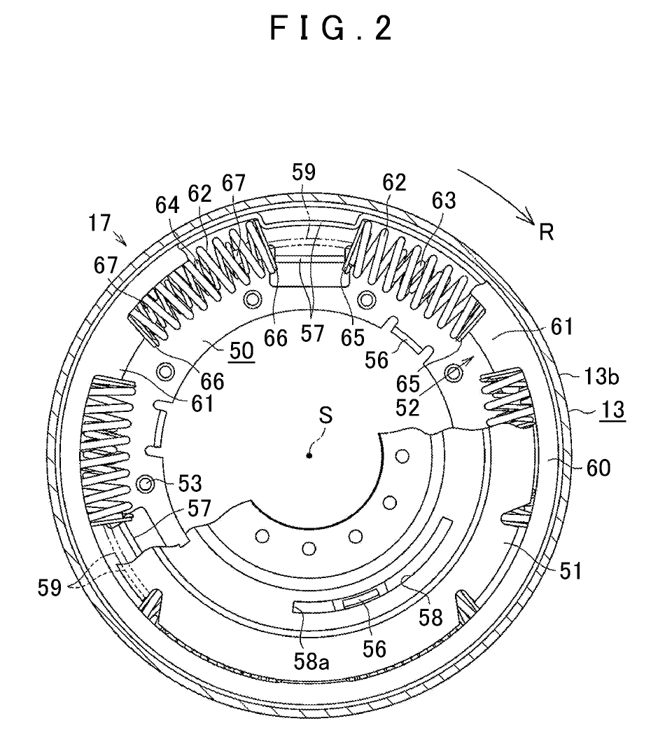

The front cover 13 includes a bottom portion 13a that is integrated with a tubular portion 13b. The bottom portion 13a is substantially disc-shaped in a plan view. The tubular portion 13b is formed about a predetermined rotation axis S (indicated by a dash-single-dot line in FIG. 1) that penetrates through a radial center of the bottom portion 13a in the front-and-rear direction. The bottom portion 13a of the front cover 13 also includes an opening 13c formed at the radial center portion of the bottom portion 13a. The opening 13c is closed by a center piece 19. When torque of the engine is transmitted, the front cover 13 is adapted to rotate in a predetermined direction R (see FIG. 2) about the rotation axis S.

The pump cover 14 is a substantially annular shape to close an opening in the rear side of the tubular portion 13b in the front cover 13. A cylindrical sleeve 20 to be connected to a drive shaft of an oil pump of an automatic transmission (not shown) is fixed to a center portion of the pump cover 14. The input shaft 12 of the speed change mechanism penetrates through the sleeve 20. Specifically, the input shaft 12 has a forward portion accommodated inside the housing 15.

In addition, the input shaft 12 includes two flow paths 21, 22 formed therein. Of the two flow paths 21, 22 extending in the front-and-rear direction, a first flow path 21 has a front end closed by a closing member 23. The input shaft 12 further includes a fluid flow-out path 24 formed therein. The fluid flow-out path 24 extends radially outwardly from the first flow path 21. The hydraulic fluid that flows through the first flow path 21 flows out of the input shaft 12 via the fluid flow-out path 24. The hydraulic fluid that flows into a second flow path 22, on the other hand, flows out of the input shaft 12 through an opening in the second flow path 22 before flowing radially outwardly along the bottom portion 13a of the front cover 13. Any excess hydraulic fluid in the housing 15 flows out of the housing 15, specifically, out of the starting device 11 by way of a flow-out flow path 25 formed between an inner peripheral surface of the sleeve 20 and an outer peripheral surface of the input shaft 12.

A turbine hub 26 is disposed on the outer peripheral side of the input shaft 12 and is immovably supported on the input shaft 12. The turbine hub 26 includes a cylindrical portion 26a integrally formed with a flange portion 26b. The cylindrical portion 26a is disposed about the rotation axis S. The flange portion 26b is disposed at a rear end of the cylindrical portion 26a. An annular fluid storage chamber 27 that temporarily stores the hydraulic fluid flowing out from the fluid flow-out path 24 is formed as a recess between an inner peripheral surface of the cylindrical portion 26a in the turbine hub 26 and an outer peripheral surface of a portion of the input shaft 12 in the front-and-rear direction at which the fluid flow-out path 24 is formed. An annular seat member 28 which restricts the hydraulic fluid in the fluid storage chamber 27 from flowing out via the forward portion is disposed at a front end of the fluid storage chamber 27. In addition, the cylindrical portion 26a of the turbine hub 26 includes an engagement flow path 29 formed therein which allows the hydraulic fluid in the fluid storage chamber 27 to flow out onto an outer peripheral side of the cylindrical portion 26a. The hydraulic fluid flowing to the outer peripheral side of the cylindrical portion 26a in the turbine hub 26 through the engagement flow path 29 flows radially outwardly along the flange portion 26b of the turbine hub 26.

The clutch mechanism 18 will next be described with reference to FIG. 1.

Referring to FIG. 1, the clutch mechanism 18 includes a sleeve-like clutch hub 30 and a substantially cylindrical clutch drum 31. The clutch hub 30 is connected to the damper device 17 (specifically, a damper disc 51 to be described later). The clutch drum 31 has a rear end fixed to the flange portion 26b of the turbine hub 26. A driven side member of the fluid coupling 16 is connected to the clutch drum 31 via a turbine shell 32.

The clutch mechanism 18 includes a piston 33 that is substantially annular in a plan view. The piston 33 is disposed on an inner peripheral side of the clutch drum 31 and at a front side of the flange portion 26b of the turbine hub 26. The piston 33 is supported movably in the front-and-rear direction relative to the turbine hub 26. In addition, a release space 34 is formed forwardly of the piston 33. A return spring seat 35 and a return spring 36 are disposed inside the release space 34. The return spring seat 35 having a substantially annular shape in a plan view is immovably supported on the clutch drum 31. The return spring 36 is supported on the return spring seat 35 and urges the piston 33 rearwardly.

A plurality of (four in FIG. 1) first clutch plates 37 disposed along the front-and-rear direction is supported movably in the front-and-rear direction on an outer peripheral side of a cylindrical portion of the clutch hub 30. Additionally, a plurality of (four in FIG. 1) second clutch plates 38 disposed along the front-and-rear direction is supported movably in the front-and-rear direction on an inner peripheral side of the clutch drum 31. Each of the second clutch plates 38 is disposed in the front-and-rear direction between each pair of adjacent first clutch plates 37, or between the rearmost first clutch plate 37 and the piston 33.

The piston 33 therefore moves forward when, based on supply of the hydraulic fluid from the first flow path 21, a hydraulic fluid pressure in an engagement space 39 between the flange portion 26b of the turbine hub 26 and the piston 33 becomes greater than a sum of an urging force of the return spring 36 and a hydraulic fluid pressure in the release space 34. As a result, hydraulic fluid disposed between the first clutch plate 37 and the second clutch plate 38 adjacent each other in the front-and-rear direction is made to flow radially outwardly by a pressure of the piston 33, so that the first clutch plate 37 and the second clutch plate 38 adjacent each other in the front-and-rear direction are engaged with each other. Accordingly, the torque from the engine is directly transmitted to the input shaft 12 of the speed change mechanism via the clutch mechanism 18.

The piston 33 moves rearward, on the other hand, if based on the supply of the hydraulic fluid from the second flow path 22, the sum of the hydraulic fluid pressure in the release space 34 and the urging force of the return spring 36 becomes greater than the hydraulic fluid pressure in the engagement space 39. As a result, the hydraulic fluid that flows from the side of the release space 34 is disposed between the first clutch plate 37 and the second clutch plate 38 adjacent each other in the front-and-rear direction, so that the first clutch plate 37 and the second clutch plate 38 adjacent each other in the front-and-rear direction are disengaged from each other.

The damper device 17 will next be described with reference to FIGS. 1 through 3. In FIG. 2, the input shaft 12, the clutch mechanism 18, and the turbine hub 26 are omitted for convenience in explaining this exemplary embodiment.

Referring to FIGS. 1 and 2, the damper device 17 includes a damper plate 50 and a damper disc 51. The damper plate 50 serves as a drive plate that is coaxially rotatable with the front cover 13. The damper disc 51 serves as a driven plate. The damper disc 51 is disposed in rear of the damper plate 50. The damper device 17 also includes a torque transmission mechanism 52 for transmitting torque of the damper plate 50 to the damper disc 51.

The damper plate 50 is formed from a single metal plate that is formed into a substantially cylindrical shape with a bottom. Specifically, the damper plate 50 includes a bottom portion 50a and a tubular portion 50b. The bottom portion 50a forms a substantially annular shape formed about the rotation axis S. The tubular portion 50b is formed about the rotation axis S. The damper plate 50 is fixed in place with a front surface of the bottom portion 50a in tight contact with the bottom portion 13a of the front cover 13. Specifically, the bottom portion 13a of the front cover 13 includes a plurality of (only five of them are shown in FIG. 2) locking protruding portions (positioning portions) 53 disposed in a circumferential direction thereof, each being equally spaced apart from each other. The locking protruding portions 53 protrude rearwardly and are disposed at a slightly outward side radially relative to an intermediate portion of the bottom portion 13a. In addition, the damper plate 50 includes a plurality of (only one of them is shown in FIG. 1) locking holes (positioning portions) 54 formed in the circumferential direction thereof, each being equally spaced apart from each other. The locking holes 54 are disposed at the same radial positions as the locking protruding portions 53, each corresponding individually to each of the locking protruding portions 53. The damper plate 50 is fixed to the bottom portion 13a of the front cover 13 as follows. Specifically, each of the locking protruding portions 53 corresponding individually to each of the locking holes 54 is inserted in the corresponding one of the locking holes 54 and a head portion (the left end portion in FIG. 1) of each of the locking protruding portions 53 is then caulked.

The damper plate 50 further includes a plurality of (three in the present exemplary embodiment) protruding portions 56 protruding rearwardly formed at radially inward portions. Each of the protruding portions 56 is disposed equally spaced apart from each other in the circumferential direction. A plurality of (three in the present exemplary embodiment) first torque transmission portions 57 protruding rearwardly are formed at radially outward portions of the damper plate 50. Each of the first torque transmission portions 57 protruding rearwardly is disposed equally spaced apart from each other in the circumferential direction. Further, a rear end of each of the first torque transmission portions 57 is disposed rearwardly of a rear end of each of the protruding portions 56.

The damper disc 51 is formed from a single metal plate that is formed into a substantially annular shape having a center thereof at the rotation axis S. Specifically, the damper disc 51 is formed such that a radially outward portion that is to be disposed radially outwardly of each of the locking protruding portions 53 is disposed rearwardly of a radially inward portion that is to be disposed radially inwardly of each of the locking protruding portions 53. The damper disc 51 is fixed in position with the radially inward portion supported on the clutch hub 30. The damper disc 51 includes in the radially inward portion a plurality of (three in the present exemplary embodiment) guide holes 58 formed therein, each corresponding individually to each of the protruding portions 56. Each of the guide holes 58 is formed so as to extend circumferentially, and is disposed at a radial position that is the same as the radial position of each of the respective protruding portions 56. Each of the protruding portions 56 penetrates through a corresponding one of the guide holes 58. When the damper plate 50 rotates in the predetermined direction R relative to the damper disc 51 through a rotation angle (also called “torsion angle”) and when the rotation angle of the damper plate 50 relative to the damper disc 51 becomes a third predetermined angle, each of the protruding portions 56 of the damper plate 50 is to abut each edge portion 58a of each of the guide holes 58 on the side of the predetermined direction R.

The radially outward portion of the damper disc 51 includes a plurality of (three in the present exemplary embodiment) second torque transmission portions 59 (indicated by a dash-double-dot line in FIG. 2) formed so as to protrude forwardly. Each of the second torque transmission portions 59 is disposed equally spaced apart from each other in the circumferential direction. Each of these second torque transmission portions 59 has a front end disposed at the same position in the front-and-rear direction and in the circumferential direction as the rear end of each of the first torque transmission portions 57. The second torque transmission portions 59 are disposed at radially different positions from the first torque transmission portions 57.

The torque transmission mechanism 52 includes an annular intermediate plate 60 that is rotatable about the rotation axis S. The intermediate plate 60 is formed to have an inside diameter larger than an outside diameter of the damper disc 51 and an outside diameter that is substantially equal to that of the damper plate 50. The intermediate plate 60 includes a plurality of (three in the present exemplary embodiment) third torque transmission portions 61 that protrude radially inwardly from an inner peripheral edge thereof. Each of the third torque transmission portions 61 is disposed equally spaced apart from each other in the circumferential direction. Each of these third torque transmission portions 61 is disposed at a position between the first torque transmission portion 57 disposed on a side circumferentially opposite the predetermined direction R, and the second torque transmission portion 59 disposed on a side of the predetermined direction R (more specifically, an intermediate position) and, in the front-and-rear direction and the radial direction, at substantially the same position as each of the other torque transmission portions 57, 59.

The torque transmission mechanism 52 further includes a plurality of types (three in the present exemplary embodiment) of damper springs 62, 63, 64, each having a different diameter from each other or a different length from each other in an extension/compression direction in a steady state, i.e., when no stress in the extension/compression direction is applied. Each of these damper springs 62 to 64 is disposed along an inner peripheral surface of the tubular portion 13b of the front cover 13. Therefore, if a centrifugal force generated during rotation of the damper device 17 in the predetermined direction R causes each of these damper springs 62 to 64 to be displaced radially outwardly, the radially outward displacement of each of the damper springs 62 to 64 is restricted by the tubular portion 13b of the front cover 13.

In the torque transmission mechanism 52 according to the present exemplary embodiment, each of the damper springs 62 to 64 is disposed such that the combination of the damper springs acting during torque transmission from the damper plate 50 to the damper disc 51 is changed three times as the damper plate 50 rotates through a larger angle relative to the damper disc 51.

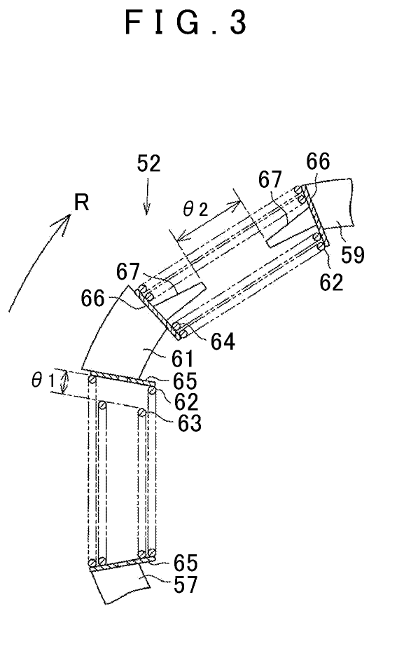

Specifically, referring to FIGS. 2 and 3, the damper springs 62, 63 of a plurality of types (two types in the present exemplary embodiment), each having a different diameter from each other and a different length from each other in the extension/compression direction in the steady state, are disposed in an overlapping manner such that they coaxially overlap each other in the circumferential direction, on the side of each of the third torque transmission portions 61 opposite the predetermined direction R. Specifically, a second damper spring 63 having a smaller diameter is accommodated in a space defined within a first damper spring 62 having a larger diameter. Of these damper springs 62, 63, the first damper spring 62 is capable of transmitting torque individually to each of the first torque transmission portions 57 and the third torque transmission portions 61 in the steady state. The second damper spring 63, on the other hand, is shorter in length in the extension/compression direction in the steady state than the first damper spring 62. Specifically, the second damper spring 63 becomes able to transmit torque individually to each of the first torque transmission portions 57 and the third torque transmission portions 61 when the damper plate 50 rotates in the predetermined direction R relative to the damper disc 51 and the above-described rotation angle becomes equal to, or more than, a first predetermined angle θ1 that is previously set to change the combination of the damper springs acting during torque transmission. The first predetermined angle is an angle that is smaller than the third predetermined angle.

An annular seat member 65 interposed between the torque transmission portions 57, 61 that circumferentially adjoin each other is disposed on each of both ends of the first damper spring 62 in the extension/compression direction disposed on the side of each of the third torque transmission portions 61 opposite the predetermined direction R. Each of these seat members 65 is formed so as to abut an end of the second damper spring 63 in the extension/compression direction when the damper plate 50 rotates in the predetermined direction R relative to the damper disc 51 and the above-described rotation angle becomes equal to, or more than, the first predetermined angle.

The damper springs 62, 64 of a plurality of types (two types in the present exemplary embodiment), each having a different diameter from each other, are disposed in an overlapping manner on the side of each of the third torque transmission portions 61 in the predetermined direction R. Specifically, a third damper spring 64 having a smaller diameter is accommodated in a space defined within the first damper spring 62 having a larger diameter. Each of the damper springs 62, 64 has substantially the same length in the extension/compression direction in the steady state, and is capable of transmitting torque individually to each of the third torque transmission portions 61 and the second torque transmission portions 59 in the steady state. Of the damper springs 62, 64, the first damper spring 62 having a larger diameter is of the same type as the first damper spring 62 disposed on the side of the third torque transmission portions 61 opposite the predetermined direction R.

A substantially circular seat member 66 interposed between the torque transmission portions 59, 61 that circumferentially adjoin each other is disposed on each of both ends of the first damper spring 62 in the extension/compression direction located on the side of each of the third torque transmission portions 61 in the predetermined direction R. The pair of seat members 66 disposed on both ends of the first damper spring 62 in the extension/compression direction is formed so as to abut the ends of the third damper spring 64 in the extension/compression direction located inside the first damper spring 62. Each of the pair of seat members 66 includes a stopper (protrusion) 67 that serves as a restriction portion extending in a direction of mutually approaching inside the third damper spring 64. Each of the stoppers 67 is formed to taper gradually as they approach each other. Further, the two stoppers 67 are arranged so that front ends thereof contact each other when the damper plate 50 rotates in the predetermined direction R relative to the damper disc 51 and the above-described rotation angle becomes equal to, or more than, a second predetermined angle θ2 that is previously set to change the combination of the damper springs acting during torque transmission again. The second predetermined angle is an angle that is greater than the first predetermined angle and smaller than the third predetermined angle.

Operation of the damper device 17 will be described below.

When torque is transmitted to the damper device 17 from the engine side, the damper plate 50 and the damper disc 51 rotate along the predetermined direction R, respectively, about the rotation axis S in a condition of having a rotation angle corresponding to the magnitude of the torque. Specifically, when the rotation angle of the damper plate 50 relative to the damper disc 51 is less than the first predetermined angle θ1, the torque transmitted from the engine side to the damper plate 50 is transmitted, in sequence, to the first torque transmission portions 57, the first damper spring 62, the third torque transmission portions 61, the first damper spring 62 and the third damper spring 64, and the second torque transmission portions 59 (more specifically, the damper disc 51) before being transmitted to the side of the clutch mechanism 18.

When the engine torque becomes greater and the rotation angle of the damper plate 50 relative to the damper disc 51 is equal to, or more than, the first predetermined angle θ1 and less than the second predetermined angle θ2, the second damper spring 63 disposed between the first torque transmission portions 57 and the third torque transmission portions 61 also becomes able to transmit torque to the two torque transmission portions 57, 61. Accordingly, the torque transmitted from the engine side to the damper plate 50 is transmitted, in sequence, to the first torque transmission portions 57, the first damper spring 62 and the second damper spring 63, the third torque transmission portions 61, the first damper spring 62 and the third damper spring 64, and the second torque transmission portions 59 before being transmitted to the side of the clutch mechanism 18. A torque transmission path from the damper plate 50 to the damper disc 51 is therefore changed from that when the rotation angle is the first predetermined angle θ1.

When the engine torque becomes even greater and the rotation angle of the damper plate 50 relative to the damper disc 51 is equal to, or more than, the second predetermined angle θ2, the pair of stoppers 67 disposed between the third torque transmission portions 61 and the second torque transmission portions 59 restrict compression of the first damper spring 62 and the third damper spring 64. Specifically, the third torque transmission portions 61 and the second torque transmission portions 59 are directly connected to each other. Accordingly, the torque transmitted from the engine side to the damper plate 50 is transmitted, in sequence, to the first torque transmission portions 57, the first damper spring 62 and the second damper spring 63, the third torque transmission portions 61, and the second torque transmission portions 59 before being transmitted to the side of the clutch mechanism 18. The torque transmission path from the damper plate 50 to the damper disc 51 is therefore changed again from that when the rotation angle is the second predetermined angle θ2.

When the engine torque becomes even greater and the rotation angle of the damper plate 50 relative to the damper disc 51 becomes the third predetermined angle θ3 that is greater than the second predetermined angle θ2, each of the protruding portions 56 of the damper plate 50 abuts each edge portion 58a of each of the guide holes 58 on the side of the predetermined direction R in the damper disc 51. As a result, the rotation angle of the damper plate 50 relative to the damper disc 51 can be avoided from becoming more than the third predetermined angle θ3. Specifically, the damper plate 50 and the damper disc 51 are directly connected to each other. In this case, the torque transmitted from the engine side to the damper plate 50 is directly transmitted from the damper plate 50 to the damper disc 51, and then to the side of the clutch mechanism 18.

The present exemplary embodiment can therefore achieve the following effects.

In the damper device 17 that allows the combination of the damper springs acting during torque transmission from the damper plate 50 to the damper disc 51 to be changed three times as the rotation angle of the damper plate 50 relative to the damper disc 51 becomes greater, all damper springs 62 to 64 are disposed at the same radial positions. Therefore, as compared with the related art in which the damper springs 62 to 64 are disposed at a plurality of positions, each being radially different from each other, this arrangement can contribute to a reduction in radial size.

The second damper spring 63 or the third damper spring 64 is accommodated in the internal space of the first damper spring 62, so that the damper springs 62 to 64 of two different types are disposed in an overlapping manner in the circumferential direction. As compared with an arrangement in which the damper springs 62 to 64 do not overlap each other in the circumferential direction, the space for disposing the damper springs in the circumferential direction can be reduced. Thus, this arrangement can contribute to a size reduction of the damper device 17.

By combining the damper springs 62 to 64 of three different types with the pair of stoppers 67 serving as the restriction portion, three different combinations of the damper springs acting during torque transmission from the damper plate 50 to the damper disc 51 can be set according to the rotation angle of the damper plate 50 relative to the damper disc 51.

The damper spring of the same type is used for the first damper spring 62 disposed on the side of the third torque transmission portions 61 opposite the predetermined direction R and for the first damper spring 62 disposed on the side of the third torque transmission portions 61 in the predetermined direction R, when either may be a damper spring having at least a different length in the extension/compression direction in the steady state or a different extension/compression ratio. This arrangement inhibits the number of types of damper springs 62 to 64 used in the damper device 17 from increasing, and thus can contribute to a reduction in manufacturing cost.

The second damper spring 63 having a shorter length in the extension/compression direction in the steady state than the first damper spring 62 is accommodated in the internal space of the first damper spring 62. The internal space of the first damper spring 62 can therefore be effectively used.

Each of the stoppers 67 is disposed in the internal space of the third damper spring 64. Therefore, as compared with a case in which the stoppers 67 are disposed at a radially different position from the damper spring 64, this arrangement can contribute to a reduction in the radial size of the damper device 17.

The stopper 67 according to the present exemplary embodiment is a protrusion formed on the seat member 66. As compared with an arrangement in which the stopper 67 is formed separately from the seat member 66, therefore, the number of parts used can be reduced.

Further, each of the stoppers 67 is formed to taper gradually from a proximal end to a distal end thereof. Unlike an arrangement in which the stopper 67 is columnar, the compressed third damper spring 64 can be inhibited from contacting the stopper 67.

### Second Exemplary Embodiment

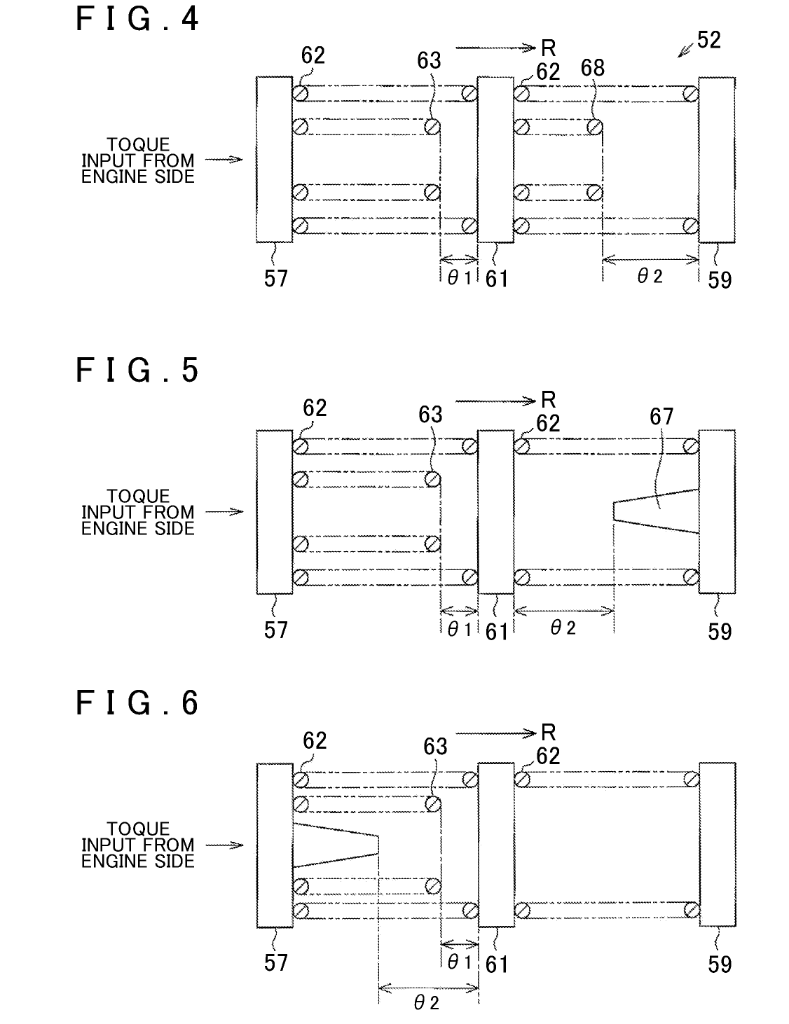

A second exemplary embodiment of the present invention will be described below with reference to FIG. 4. The second exemplary embodiment differs from the first exemplary embodiment in the arrangement of the torque transmission mechanism 52. Therefore, the following descriptions are concerned mainly with differences from the first exemplary embodiment and descriptions of similar members will not be duplicated by denoting those same or corresponding members with the same reference numerals. In FIG. 4, the seat members 65, 66 are omitted for convenience in explaining this exemplary embodiment.

Referring to FIG. 4, in a torque transmission mechanism 52 according to the present exemplary embodiment, damper springs 62, 63 of two different types, each having a different diameter and a different length in an extension/compression direction in a steady state, are disposed in an overlapping manner on the side of a third torque transmission portion 61 opposite a predetermined direction R. Specifically, of these damper springs 62, 63, the first damper spring 62 having a larger diameter is structured to be capable of transmitting torque individually to each of a first torque transmission portion 57 and the third torque transmission portion 61 in a steady state. The second damper spring 63 that is smaller in diameter than the first damper spring 62 is, on the other hand, accommodated in an internal space of the first damper spring 62. In addition, the second damper spring 63 is structured to be capable of transmitting torque individually to each of the first torque transmission portion 57 and the third torque transmission portion 61 when a damper plate 50 rotates in the predetermined direction R relative to a damper disc 51 and the above-described rotation angle becomes equal to, or more than, the above-described first predetermined angle θ1.

On the side of the third torque transmission portion 61 in the predetermined direction R, on the other hand, damper springs 62, 68 of two different types, each having a different diameter and a different length in the extension/compression direction in the steady state, are disposed in an overlapping manner. Specifically, of these damper springs 62, 68, the first damper spring 62 having a larger diameter is structured to be capable of transmitting torque individually to each of a second torque transmission portion 59 and the third torque transmission portion 61 in a steady state. The third damper spring 68 that is smaller in diameter than the first damper spring 62 is, on the other hand, accommodated in the internal space of the first damper spring 62. In addition, the third damper spring 68 is structured to be capable of transmitting torque individually to each of the second torque transmission portion 59 and the third torque transmission portion 61 when the damper plate 50 rotates in the predetermined direction R relative to the damper disc 51 and the above-described rotation angle becomes equal to, or more than, the above-described second predetermined angle θ2. Specifically, the third damper spring 68 has a shorter length in the extension/compression direction in the steady state than the second damper spring 63.

Accordingly, when the rotation angle of the damper plate 50 relative to the damper disc 51 is less than the first predetermined angle θ1, the torque transmitted from the engine side to the damper plate 50 is transmitted, in sequence, to the first torque transmission portion 57, the first damper spring 62, the third torque transmission portion 61, the first damper spring 62, and the second torque transmission portion 59 before being transmitted to the side of a clutch mechanism 18. When the engine torque becomes greater and the rotation angle of the damper plate 50 relative to the damper disc 51 is equal to, or more than, the first predetermined angle θ1 and less than the second predetermined angle θ2, the second damper spring 63 disposed between the first torque transmission portion 57 and the third torque transmission portion 61 also becomes able to transmit torque to the first torque transmission portion 57 and the third torque transmission portion 61. Accordingly, the torque transmitted from the engine side to the damper plate 50 is transmitted, in sequence, to the first torque transmission portion 57, the first damper spring 62 and the second damper spring 63, the third torque transmission portion 61, the first damper spring 62, and the second torque transmission portion 59 before being transmitted to the side of the clutch mechanism 18.

When the engine torque becomes even greater and the rotation angle of the damper plate 50 relative to the damper disc 51 is equal to, or more than, the second predetermined angle θ2, the third damper spring 68 disposed between the second torque transmission portion 59 and the third torque transmission portion 61 also becomes capable of transmitting torque to the second torque transmission portion 59 and the third torque transmission portion 61. Accordingly, the torque transmitted from the engine side to the damper plate 50 is transmitted, in sequence, to the first torque transmission portion 57, the first damper spring 62 and the second damper spring 63, the third torque transmission portion 61, the first damper spring 62 and the third damper spring 68, and the second torque transmission portion 59 before being transmitted to the side of the clutch mechanism 18.

The present exemplary embodiment can therefore achieve the following effects, in addition to the effects of (1) and (2) of the first exemplary embodiment.

(9) In the present exemplary embodiment, unlike the above-described first exemplary embodiment, through the combination of the damper springs 62, 63, 68 of three different types without the use of any restriction portion, the combination of the damper springs acting during torque transmission from the damper plate 50 to the damper disc 51 can be changed three times as the rotation angle of the damper plate 50 relative to the damper disc 51 becomes greater. Therefore, this arrangement can contribute to a reduction of the number of parts used for the restriction portion that can be omitted.

(10) The second damper spring 63 and the third damper spring 68 having a shorter length in the extension/compression direction in the steady state than the first damper spring 62 is accommodated in the internal space of the first damper spring 62. The internal space of the first damper spring 62 can therefore be effectively used.

### Third Exemplary Embodiment

A third exemplary embodiment of the present invention will be described below with reference to FIG. 5. The third exemplary embodiment differs from each of the first and second exemplary embodiments in the arrangement of the torque transmission mechanism 52. Therefore, the following descriptions are concerned mainly with differences from each of the first and second exemplary embodiments and descriptions of similar members will not be duplicated by denoting those same or corresponding members with the same reference numerals. In FIG. 5, the seat members 65, 66 are omitted for convenience in explaining this exemplary embodiment.

Referring to FIG. 5, in a torque transmission mechanism 52 according to the present exemplary embodiment, a first damper spring 62 capable of transmitting torque individually to each of a second torque transmission portion 59 and a third torque transmission portion 61 in the steady state is disposed on the side of the third torque transmission portion 61 in a predetermined direction R. A stopper (protrusion) 67 that serves as a restriction portion extending from the second torque transmission portion 59 toward the third torque transmission portion 61 is disposed in an internal space of the first damper spring 62. The stopper 67 is structured such that the second torque transmission portion 59 and the third torque transmission portion 61 are restricted from relatively approaching each other when a damper plate 50 rotates in the predetermined direction R relative to a damper disc 51 and the above-described rotation angle becomes equal to, or more than, the above-described second predetermined angle θ2.

Accordingly, when the rotation angle of the damper plate 50 relative to the damper disc 51 is less than the first predetermined angle θ1, the torque transmitted from the engine side to the damper plate 50 is transmitted, in sequence, to a first torque transmission portion 57, the first damper spring 62, the third torque transmission portion 61, the first damper spring 62, and the second torque transmission portion 59 before being transmitted to the side of a clutch mechanism 18. When the engine torque becomes greater and the rotation angle of the damper plate 50 relative to the damper disc 51 is equal to, or more than, the first predetermined angle θ1 and less than the second predetermined angle θ2, the torque is transmitted, in sequence, to the first torque transmission portion 57, the first damper spring 62 and a second damper spring 63, the third torque transmission portion 61, the first damper spring 62, and the second torque transmission portion 59 before being transmitted to the side of the clutch mechanism 18. When the engine torque thereafter becomes even greater and the rotation angle of the damper plate 50 relative to the damper disc 51 is equal to, or more than, the second predetermined angle θ2, the stopper 67 restricts the relative approach between the second torque transmission portion 59 and the third torque transmission portion 61. Accordingly, the torque is transmitted, in sequence, to the first torque transmission portion 57, the first damper spring 62 and the second damper spring 63, the third torque transmission portion 61, and the second torque transmission portion 59 before being transmitted to the side of the clutch mechanism 18.

The present exemplary embodiment can therefore achieve the following effect, in addition to the effects of (1), (2), and (4) to (6) of each of the above-described exemplary embodiments.

(10) By combining the damper springs 62, 63 of two different types and the stopper 67 serving as the restriction portion, the combination of the damper springs acting during torque transmission from the damper plate 50 to the damper disc 51 can be changed three times as the rotation angle of the damper plate 50 relative to the damper disc 51 becomes greater. Therefore, this arrangement can contribute to a reduction in manufacturing cost for the reduced number of types of the damper springs 62, 63 used as compared with each of the above-described exemplary embodiments.

Each of the above-described exemplary embodiments may be modified differently as described below.

In the third exemplary embodiment, the stopper 67 may be disposed between the first torque transmission portion 57 and the third torque transmission portion 61 as shown in FIG. 6. The stopper 67 has a length in the circumferential direction shorter than the length of the second damper spring 63 in the extension/compression direction in the steady state. Even with such an arrangement, three different combinations of the damper springs acting during torque transmission from the damper plate 50 to the damper disc 51 can be provided according to the rotation angle of the damper plate 50 relative to the damper disc 51 by combining the damper springs 62, 63 of two different types and the stopper 67 serving as the restriction portion.

In each of the first and third exemplary embodiments, the stopper 67 may be columnar. Alternatively, the stopper 67 may be arcuate about the rotation axis S.

In each of the first and third exemplary embodiments, the stopper 67 may be formed separately from the seat members 65, 66.

In each of the first and third exemplary embodiments, the stopper 67 may be disposed at a position adjacent the damper springs 62 to 64 in the front-and-rear direction, instead of inside the damper springs 62 to 64, as long as the stopper 67 is radially disposed at the same position as the damper springs 62 to 64.

In each of the first and third exemplary embodiments, the stopper 67 may be disposed at a position radially different from the damper springs 62 to 64. In this case, a radial dimension can become larger than in each of the first and third exemplary embodiments; however, the radial dimension can be inhibited from increasing more than in an arrangement in which each of the damper springs 62 to 64 is disposed at a radially different position.

In the first exemplary embodiment, the shape (specifically, length) of the stopper 67 or the length of the second damper spring 63 in the steady state may be changed so that the first predetermined angle θ1 is greater than the second predetermined angle θ2.

In the first exemplary embodiment, the damper device 17 may be arranged such that the second damper spring 63 is disposed on the side of the third torque transmission portion 61 in the predetermined direction R and the third damper spring 64 is disposed on the side of the third torque transmission portion 61 opposite the predetermined direction R.

In the third exemplary embodiment, the shape (specifically, length) of the stopper 67 or the length of the second damper spring 63 in the steady state may be changed so that the first predetermined angle θ1 is greater than the second predetermined angle θ2.

In the third exemplary embodiment, the length of the first damper spring 62 in the steady state on the side of the third torque transmission portion 61 in the predetermined direction R may be set to be different from that of the first damper spring 62 in the steady state on the side of the third torque transmission portion 61 opposite the predetermined direction R.

In the third exemplary embodiment, the extension/compression ratio (specifically, spring constant) of the first damper spring 62 on the side of the third torque transmission portion 61 in the predetermined direction R may be set to be different from that of the first damper spring 62 on the side of the third torque transmission portion 61 opposite the predetermined direction R.

In each of the exemplary embodiments, the damper springs 62 to 64, 68 of various types disposed at the same circumferential position may be disposed adjacent each other in the front-and-rear direction. Such an arrangement can inhibit the radial dimension from increasing.

In each of the exemplary embodiments, the first damper spring 62 disposed on the side of the third torque transmission portion 61 in the predetermined direction R and the first damper spring 62 disposed opposite the predetermined direction R may have a different length in the extension/compression direction in the steady state or a different extension/compression ratio.

In each of the exemplary embodiments, the damper springs 63, 64, 68 having a shorter length in the extension/compression direction in the steady state may be disposed on the outer peripheral side of the first damper spring 62 having a longer length. In this case, the damper springs 63, 64, 68 may be formed to have a greater diameter than the first damper spring 62.

In each of the exemplary embodiments, the damper device 17 may be embodied such that the combination of the damper springs acting during torque transmission from the damper plate 50 to the damper disc 51 can be changed four times or more (e.g. four times) as the rotation angle of the damper plate 50 relative to the damper disc 51 becomes greater. For example, in the damper device 17 according to the second exemplary embodiment, a stopper having a length shorter than the length of the second damper spring 63 and the third damper spring 68 in the extension/compression direction in the steady state may be disposed inside the second damper spring 63, which provides four different combinations of the damper springs acting during torque transmission.

The above description of the exemplary embodiments of the invention have been given by way of example. From the disclosure given, those skilled in the art will not only understand the present invention and its attendant advantages, but will also find apparent various changes and modifications to the structures disclosed. It is sought, therefore, to cover all such changes and modifications as fall within the spirit and scope of the invention, as defined by the appended claims, and equivalents thereof.

What is claimed is:

1. A damper device comprising:
a drive plate rotatable about a predetermined rotation axis;
a driven plate disposed so as to be relatively rotatable coaxially with the drive plate; and
a torque transmission mechanism having a plurality of damper springs, at least one of the damper springs being of a different type than another one of the damper springs, wherein the types are different from each other in at least one of a radial size, a length in an extension/compression direction in a steady state, and an extension/compression ratio, the torque transmission mechanism transmitting torque of the drive plate to the driven plate via at least one of the damper springs, wherein:
the torque transmission mechanism allows a combination of damper springs acting during torque transmission from the drive plate to the driven plate to be changed at lease three times as a rotation angle of the drive plate relative to the driven plate becomes greater; and
each of the damper springs can be extended and compressed circumferentially about the rotation axis and is disposed at the same radial position about the rotation axis relative to each other.

2. The damper device according to claim 1, wherein:
a radial size of one of the damper springs is different than another one of the damper springs, and the damper springs having the different radial sizes are disposed in an overlapping manner such that the damper springs having the different radial sizes coaxially overlap each other in a circumferential direction about the rotation axis.

3. The damper device according to claim 2, wherein:
the drive plate includes a first torque transmission portion capable of transmitting torque to at least one of the damper springs in the circumferential direction;
the driven plate includes a second torque transmission portion capable of transmitting torque to at least one of the damper springs in the circumferential direction;
one of the damper spring is disposed on a side of the first torque transmission portion in the circumferential direction and another one of the damper springs is disposed on a side of the second torque transmission portion in the circumferential direction;
the torque transmission mechanism includes a third torque transmission portion capable of transmitting torque to each of the two damper springs disposed on the side of the first torque transmission portion and on the side of the second torque transmission portion; and
the damper springs having the different radial sizes are disposed at least one of: between the first torque transmission portion and the third torque transmission portion in the circumferential direction, and between the third torque transmission portion and the second torque transmission portion in the circumferential direction.

4. The damper device according to claim 3, wherein:
a radial size and a length of one of the damper springs is different from another one of the damper springs the length being in an extension/compression direction in a steady state, the damper springs of the different radial size and different length being disposed in the overlapping manner between the third torque transmission portion and another torque transmission portion, the other torque transmission portion being disposed on a first side of the third torque transmission portion in the circumferential direction,
the damper spring having a greater length than the other one of the damper springs being formed so as to be capable of transmitting torque individually to each of the two torque transmission portions disposed on either side thereof in the circumferential direction, the damper spring having a smaller length than the other one of the damper springs being formed so as to be capable of transmitting torque individually to each of the two torque transmission portions disposed on either side thereof in the circumferential direction when the rotation angle becomes equal to or more than a first predetermined angle that is set in advance to change the combination of the damper springs acting during torque transmission;
a radial size of two of the damper springs having a same length are different from one another, the length being in an extension/compression direction in a steady state, the damper springs having the different radial size and the same length being disposed in the overlapping manner between the third torque transmission portion and another torque transmission portion disposed on a second side of the third torque transmission portion in the circumferential direction, the damper springs having the different radial size and the same length being formed so as to be capable of transmitting torque at all times individually to each of the two torque transmission portions disposed on either side in the circumferential direction; and
a restriction portion being disposed between the third torque transmission portion and the other torque transmission portion disposed on the second side of the third torque transmission portion in the circumferential direction, that restricts a relative approach between the third torque transmission portion and the other torque transmission portion when the rotation angle becomes equal to or more than a second predetermined angle greater than the first predetermined angle, the second predetermined angle being set in advance to change the combination of the damper springs acting during torque transmission.

5. The damper device according to claim 4, wherein:
each of the damper springs capable of transmitting torque at all times individually to each of the two torque transmission portions disposed on either side thereof in the circumferential direction, and disposed on both sides of the third torque transmission portion in the circumferential direction, is of the same type.

6. The damper device according to claim 5, wherein:
of two of the damper springs disposed in the overlapping manner, the damper spring having a shorter length in the extension/compression direction in the steady state is formed to have a smaller radial size than the damper spring having a longer length in the extension/compression direction in the steady state and is disposed in a space formed inside the damper spring having the longer length.

7. The damper device according to claim 3, wherein:
a radial size and a length of one of the damper springs is different from another one of the damper springs the length being in an extension/compression direction in a steady state, and the damper springs having the different radial size and different length are disposed in the overlapping manner between the third torque transmission portion and another torque transmission portion, the other torque transmission portion being disposed on a first side of the third torque transmission portion in the circumferential direction, the damper spring having a greater length than the other one of the damper springs being formed so as to be capable of transmitting torque, at all times, individually to each of the two torque transmission portions disposed on either side thereof in the circumferential direction, the damper spring having a smaller length than the other one of the damper springs being formed so as to be capable of transmitting torque individually to each of the two torque transmission portions disposed on either side thereof in the circumferential direction when the rotation angle becomes equal to, or more than, a first predetermined angle that is set in advance to change the combination of the damper springs acting during torque transmission; and
another two of the damper springs having the different radial size and different length are disposed in the overlapping manner relative to one another between the third torque transmission portion and another torque transmission portion disposed on a second side of the third torque transmission portion in the circumferential direction, the damper spring having a greater length than the other one of the damper springs being formed so as to be capable of transmitting torque at all times individually to each of the two torque transmission portions disposed on either side thereof in the circumferential direction, the damper spring having a smaller length than the other one of the damper springs having the different radial length and the different length being formed so as to become able to transmit torque individually to each of the two torque transmission portions disposed on either side in the circumferential direction when the rotation angle becomes equal to, or more than, a second predetermined angle greater than the first predetermined angle, the second predetermined angle being set in advance to change the combination of the damper springs acting during torque transmission.

8. The damper device according to claim 3, wherein:
a radial size and a length of one of the damper springs is different from another one of the damper springs, the length being in an extension/compression direction in a steady state, and the damper springs having the different radial size and different length being disposed in the overlapping manner between the third torque transmission portion and another torque transmission portion disposed on a first side of the third torque transmission portion in the circumferential direction, the damper spring having a greater length than the other type of the damper springs being formed so as to be capable of transmitting torque, at all times, individually to each of the two torque transmission portions disposed on either side thereof in the circumferential direction, the damper spring having a smaller length than the other one of the damper springs having the different radial length and the different length being formed so as to be capable of transmitting torque individually to each of the two torque transmission portions disposed on either side in the circumferential direction when the rotation angle becomes equal to, or more than, a first predetermined angle that is set in advance to change the combination of the damper springs acting during torque transmission;
the damper spring capable of transmitting torque at all times individually to each of the two torque transmission portions disposed on either side thereof in the circumferential direction is disposed between the third torque transmission portion and another torque transmission portion, the other torque transmission portion being disposed on a second side of the third torque transmission portion in the circumferential direction; and
a restriction portion is disposed between the third torque transmission portion and the other torque transmission portion disposed on one of the first side and the second side of the third torque transmission portion in the circumferential direction, that restricts a relative approach between the third torque transmission portion and the other torque transmission portion disposed on one of the first side and the second side when the rotation angle becomes equal to or more than a second predetermined angle greater than the first predetermined angle, the second predetermined angle being set in advance to change the combination of the damper springs acting during torque transmission.

9. The damper device according to claim 3, wherein:
each of the damper springs capable of transmitting torque at all times individually to each of the two torque transmission portions disposed on either side thereof in the circumferential direction, of the damper springs disposed on both sides of the third torque transmission portion in the circumferential direction, is of the same type.

10. The damper device according to claim 3, wherein:
of two of the damper springs disposed in the overlapping manner, the damper spring having a shorter length in the extension/compression direction in the steady state is formed to have a smaller radial size than the damper spring having a longer length in the extension/compression direction in the steady state and is disposed in a space formed inside the damper spring having the longer length.

11. The damper device according to claim 4, wherein:
the restriction portion is disposed in a space formed inside the damper spring disposed at the same position in the circumferential direction.

12. The damper device according to claim 11, wherein:
a seat member is disposed on each end in the circumferential direction of the damper spring capable of transmitting torque at all times individually to each of the two torque transmission portions disposed on either side in the circumferential direction, the seat member being capable of abutting an end in the circumferential direction of a damper spring disposed in the overlapping manner with the damper spring capable of transmitting torque at all times individually to each of the two torque transmission portions disposed on either side in the circumferential direction; and
at least one of the two seat members includes a protrusion formed thereon, the protrusion extending in the circumferential direction inside the damper springs disposed in the overlapping manner and serving as the restriction portion.

13. The damper device according to claim 12, wherein:
the protrusion is formed to taper from a proximal end to a distal end thereof.

14. The damper device according to claim 8, wherein:
the restriction portion is disposed in a space formed inside the damper spring disposed at the same position in the circumferential direction.

15. The damper device according to claim 14, wherein:
a seat member is disposed on each end in the circumferential direction of the damper spring capable of transmitting torque at all times individually to each of the two torque transmission portions disposed on either side in the circumferential direction, the seat member being also capable of abutting an end in the circumferential direction of a damper spring disposed in the overlapping manner with the damper spring capable of transmitting torque at all times individually to each of the two torque transmission portions disposed on either side in the circumferential direction; and
at least one of the two seat members includes a protrusion formed thereon, the protrusion extending in the circumferential direction inside the damper springs disposed in the overlapping manner and serving as the restriction portion.

16. The damper device according to claim 15, wherein:
the protrusion is formed to taper from a proximal end to a distal end thereof.
